(19) United States
(12) Patent Application Publication
(10) Pub. No.: US 2026/0242191 A1
(43) Pub. Date: Aug. 20, 2026

(54) ADJUSTABLE PLATFORM FOR LIFT DEVICE

(71) Applicant: Oshkosh Corporation, Oshkosh, WI (US)

(72) Inventor: Neil Doherty, Oshkosh, WI (US)

(73) Assignee: Oshkosh Corporation, Oshkosh, WI (US)

(21) Appl. No.: 19/540,249

(22) Filed: Feb. 13, 2026

Related U.S. Application Data
(60) Provisional application No. 63/758,838, filed on Feb. 14, 2025.

(51) Int. Cl. B66F 7/08; B66F 7/06; B66F 7/28; B66F 11/04

(52) U.S. Cl. CPC B66F 7/08; B66F 7/0641; B66F 7/28; B66F 11/044

(57) ABSTRACT

One aspect relates to a lift device. The lift device may include a frame, a platform, a first arm and a second arm coupled to the platform, one or more actuators to adjust at least one of (a) a length of the first arm, (b) a length of the second arm, or (c) an angle between the first arm and the second arm, a lift apparatus coupled to the frame and the platform to adjust a height of the platform relative to the frame, and a controller. The controller may receive an input signal from a user device, operate the lift apparatus to adjust the height of the platform relative to the frame, operate the one or more actuators to adjust the length of the first arm or the second arm, and operate the one or more actuators to adjust the angle between the first arm and the second arm.

### CROSS-REFERENCE TO RELATED PATENT APPLICATION

This application claims the benefit of and priority to U.S. Provisional Patent Application No. 63/758,838, filed Feb. 14, 2025, which is incorporated herein by reference in its entirety.

### BACKGROUND

The present disclosure relates generally to construction machinery. Specifically, this disclosure relates to construction devices for lifting loads.

### SUMMARY

One embodiment relates to a lift device. The lift device may include a frame, a platform, a first arm and a second arm coupled to the platform at a proximal end of each of the first arm and the second arm, one or more actuators to adjust at least one of (a) a length of the first arm, (b) a length of the second arm, or (c) an angle between the first arm and the second arm, a lift apparatus coupled to the frame and the platform to adjust a height of the platform relative to the frame, and a controller. The controller may receive an input signal from a user device, operate the lift apparatus to adjust the height of the platform relative to the frame, operate the one or more actuators to adjust the length of the first arm or the second arm, and operate the one or more actuators to adjust the angle between the first arm and the second arm.

Another embodiment relates to a platform for a lift device. The platform may include a first arm and a second arm coupled to the platform at a proximal end of each of the first arm and the second arm, one or more actuators to adjust at least one of (a) a length of the first arm, (b) a length of the second arm, or (c) an angle between the first arm and the second arm, and a controller. The controller may receive an input signal from a user device, cause the one or more actuators to adjust the length of the first arm or the second arm, and cause the one or more actuators to adjust the angle between the first arm and the second arm.

Another embodiment relates to a lift device system. The lift device system may include a first lift device. The first lift device may include a frame, a platform, a first arm and a second arm coupled to the platform at a proximal end of each of the first arm and the second arm, one or more actuators to adjust at least one of (a) a length of the first arm, (b) a length of the second arm, or (c) an angle between the first arm and the second arm, and a lift apparatus coupled to the frame and the platform to adjust a height of the platform relative to the frame. The lift device system may include a second left device, and a controller. The controller may identify the first lift device and the second lift device for a combined operation, determine a first configuration for the first lift device, determine a second configuration for the second lift device based on the determined first configuration of the first lift device, cause a first adjustment of at least one of the lift apparatus, the first arm, or the second arm of the first lift device based on the determined second configuration of the second lift device, and cause a second adjustment of at least one of a lift apparatus, a first arm, or a second arm of the second lift device based on the first adjustment of the first lift device.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a lift device, according to an exemplary embodiment.

FIG. 2 is a perspective view of the lift device of FIG. 1 in a collapsed position, according to an exemplary embodiment.

FIG. 3 is a perspective view of the lift device of FIG. 1 in a collapsed position, according to an exemplary embodiment.

FIG. 4 is a bottom view of a tractive system for the lift device of FIG. 1, according to an exemplary embodiment.

FIG. 5 is a perspective view a braking system for the lift device of FIG. 1, according to an exemplary embodiment.

FIG. 6 is a perspective view of the lift device of FIG. 1 equipped with an adjustable platform, according to an exemplary embodiment.

FIG. 7A is a perspective view of a distal end of an arm of the platform of FIG. 6, according to an exemplary embodiment.

FIG. 7B is a perspective view of a distal end of an arm of the platform of FIG. 6, according to an exemplary embodiment.

FIG. 8 is a perspective view of the platform of FIG. 6 holding a load, according to an exemplary embodiment.

FIG. 9 is a perspective view of an operator controlling the lift device of FIG. 1, according to an exemplary embodiment.

FIG. 10 is a perspective view of a load for lifting with the lift device of FIG. 1, according to an exemplary embodiment.

FIG. 11 is a schematic block diagram of a control system for a lift device, according to an exemplary embodiment.

FIG. 12 is a flow diagram of a method for controlling the lift device of FIG. 1, according to an exemplary embodiment.

FIG. 13 is a schematic block diagram of a control system for controlling multiple lift devices, according to an exemplary embodiment.

FIG. 14 is a flow diagram of a method for controlling multiple lift devices, according to an exemplary embodiment.

### DETAILED DESCRIPTION

Before turning to the FIGURES, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, when undergoing installation of models in modular construction (e.g., off-site manufacturing), it may be desired for lift devices to be able to lift and move different pre-constructed models. These pre-constructed models may include a plurality of components of different shapes, sizes, weights, and orientations, among other features. Accordingly, a lift device with an adjustable platform for lifting loads may allow for different types of pre-constructed models to be lifted and moved for installation (e.g., at a ceiling).

A lift device may include an adjustable platform to lift and move a variety of loads. The adjustable platform may include a center platform coupled to a plurality of arms (e.g., booms). The center platform may include a plurality of tie-down points to fasten loads to the center platform. The arms may be telescoping booms with an adjustable length to accommodate (e.g., hold, contain, lift, etc.) loads of different sizes. The arms may include a plurality of tie-down points for fastening the load to the arms. The arms may be extended or retracted using actuators of the platform, or may allow for manual adjustment. Arms may be pivotably coupled to the center platform, such that an angle between a first arm and a second arm of the platform can be adjusted. The center platform may include arm pivot actuators to pivot the arms, or the arms may be pivoted manually (e.g., by an operator of the lift device).

The lift device may be coordinated with other lift devices to perform a combined operation. For example, in a modular construction installation, it may be desired to install models adjacent to one another at a ceiling of a building. As another example, a single load may be too large to be lifted by a single lift device, so multiple lift devices may coordinate to lift the load. A controller may be used to coordinate the placement, height, and platform parameters of the multiple lift devices. The controller may pair (e.g., connect, identify) the multiple lift devices via a quick response (QR) scan, bar code scan, or a radio frequency identification (RFID) scan.

### Overall Lift Device

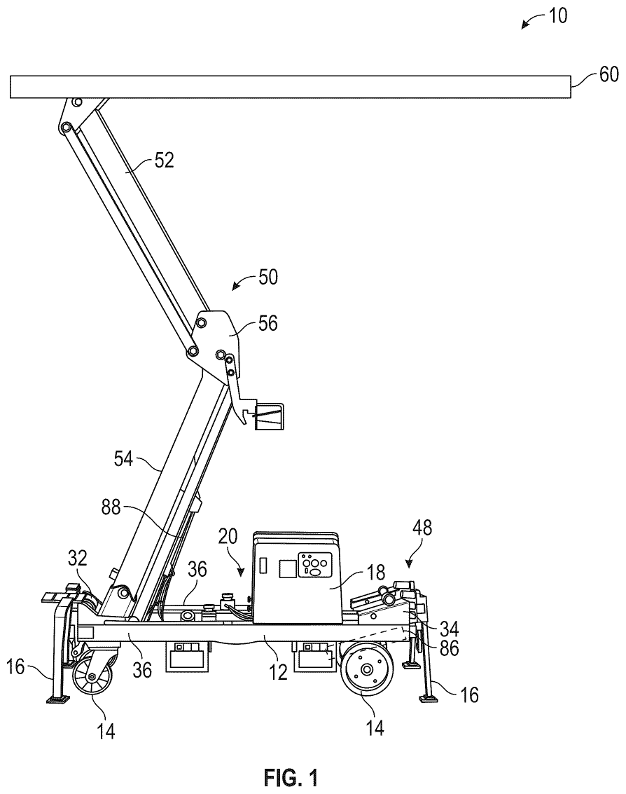

Referring to FIGS. 1-3, a lift machine (e.g., lift vehicle), is shown as lift device 10 according to an exemplary embodiment. The lift device 10 may move loads between locations where different installation operations are performed. For example, the lift device 10 may move pre-constructed models for installation in a building. Additionally or alternatively, the lift device 10 may be used to lift parts or subassemblies throughout the manufacturing environment (e.g., for installation on a ceiling of a building).

The lift device 10 includes a chassis, shown as frame 12, that supports the other components of the lift device 10. In some embodiments, the frame 12 defines a surface that supports one or more components of the lift device 10. In some embodiments, the frame 12 supports one or more components of the lift device 10 disposed on the surface of the frame 12. The frame 12 defines a front 32, a back 34, and a pair of sides 36 of the lift device 10. The frame 12 may define a top surface at the top of the frame and a bottom portion at the bottom of the frame. A distance from the top surface to the ground beneath the device 10 may define a height of the lift device 10. The front 32 is positioned at a front portion of the frame 12 and extends substantially vertically. The back 34 is positioned at a rear portion of the frame 12 and extends substantially vertically. The sides 36 each extend longitudinally between the front 32 and the back 34.

The frame 12 may include one or more tractive elements 14, a controls enclosure 18, and/or support members, shown as supporting legs 16. The tractive elements 14 may be disposed along the bottom surface of the frame 12, to facilitate motion of the frame 12 across a surface (e.g., ground, work surface, etc.). For example, the tractive elements 14 may be disposed on the bottom surface of the frame 12 in two parallel rows. As another example, the tractive elements 14 may be positioned on the bottom surface of the frame 12 at approximately each corner of the frame 12 (e.g., intersection between side 36 and front 32/back 34). The supporting legs 16 may be coupled to the front 32 and/or the back 34 of the lift device 10. For example, there may be four supporting legs 16, each supporting leg 16 positioned at approximately each corner of the frame 12. The supporting legs 16 may restrict movement of the tractive elements 14 when in a deployed state. For example, the supporting legs 16 may be longer (e.g., taller) than the height of the frame 12, such that when the supporting legs 16 are in the deployed state, the tractive elements 14 are lifted from the ground. The controls enclosure 18 may be fixedly coupled to a side 36 of the frame 12. The controls enclosure 18 may include various components (e.g., batteries, control systems, motor controllers, etc.) capable of controlling various actuators of the lift device 10. The width of the controls enclosure 18 may be approximately equal to a width of the side 36, such that a recess or passage, shown as implement recess 20, is defined longitudinally between the front 32 and the back 34, and laterally between the side surfaces 36.

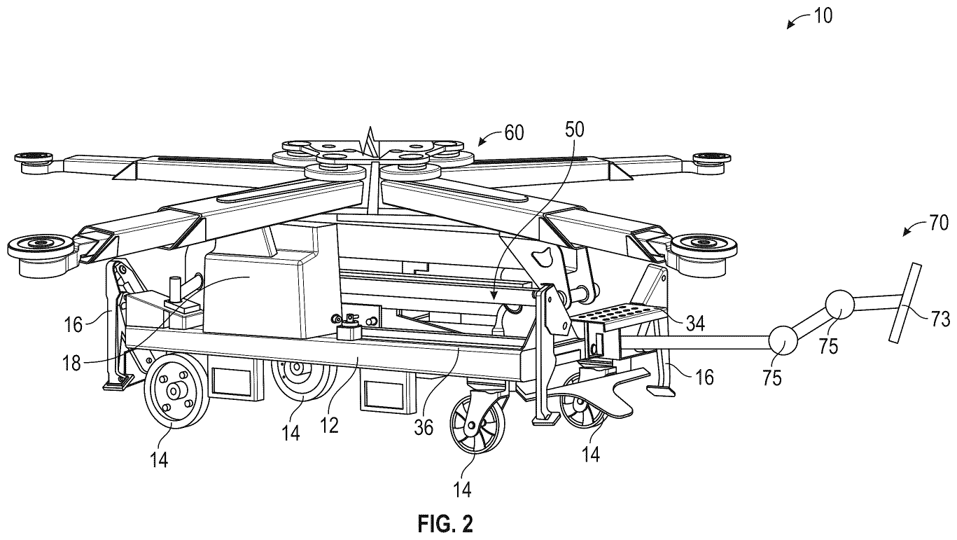

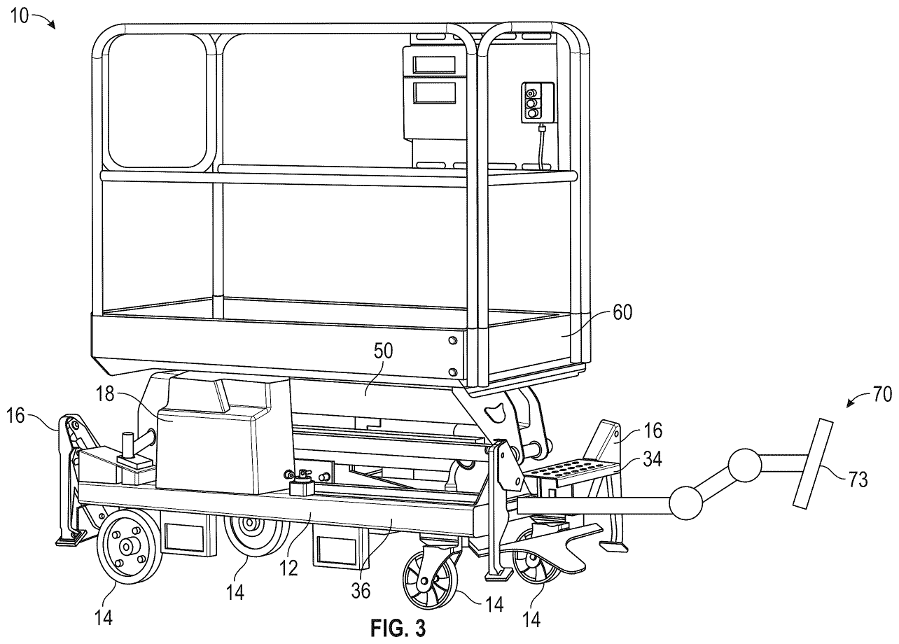

The tractive elements 14 may include components that facilitate movement of the lift device 10 (e.g., the frame 12) on the ground. For example, the tractive elements 14 may include wheels, tracks, or other components that allow the frame 12 to move on the ground. In some embodiments, the tractive elements 14 include actuators (e.g., hydraulic motors, pneumatic motors, electric motors, etc.), shown as prime movers 86, to facilitate movement of the lift device 10. For example, the tractive elements 14 can include an electric motor to move the tractive elements 14. The controls enclosure 18 may include components that facilitate powering or control over the tractive elements 14 (e.g., battery, motor controllers, etc.). In some embodiments, the tractive elements 14 do not include actuators to facilitate movement of the lift device 10 and are manually moved by an operator of the lift device 10. According to an exemplary embodiment shown in FIGS. 2 and 3, the frame 12 may include a handle 70 to push and/or pull the lift device 10 on the ground. In some embodiments, the handle 70 includes a plurality of locking articulating knuckles 75 to adjust a height of a handle interface 73 of the handle 70. For example, the locking articulating knuckles 75 can be arranged to adjust a height of the handle interface 73, such that an operator of the lift device 10 can select an optimal height to push and/or pull the lift device 10.

The frame 12, the tractive elements 14, and various other components coupled to the frame 12 (e.g., controls enclosure 18, supporting legs 16) form a base portion of the lift device 10, shown as base assembly 48. To facilitate moving (e.g., lifting) a load (e.g., product, model), the lift device 10 may include a lifting implement 50 that that can lift the product to various heights above the base assembly 48. For example, the lifting implement 50 may be any of a boom lift, a scissor lift, a tower lift, or any other type of lifting apparatus. According to the exemplary embodiment shown in FIGS. 1 and 2, the lifting implement 50 is an articulated boom lift that includes a plurality of four bar linkages to adjust the height of loads above the base assembly 48. One end of the lifting implement 50 may be pivotably coupled to the frame 12. For example, the lifting implement 50 may be coupled to the front 32 of the frame 12. The lifting implement 50 includes an upper four-bar linkage 52 and a lower four-bar linkage 54 to adjust the height of the lifting implement 50 between a raised position, as shown in FIG. 1, and a collapsed position, as shown in FIG. 2. In the fully raised position, the upper four-bar linkage 52 and the lower four-bar linkage 54 may be at a plurality of heights above the front 32 of the lift device 10. In the collapsed position, the lifting implement 50 may be received within the implement recess 20, and the upper four-bar linkage 52 may be approximately parallel to the lower four-bar linkage 54 within the implement recess 20.

The upper four-bar linkage 52 and the lower four-bar linkage 54 may be pivotally coupled (e.g., connected) by a pivot assembly 56, such that the upper linkage and the lower linkage can move (e.g., raise, lower) independently. For example, the upper four-bar linkage 52 can pivot relative to the pivot assembly 56, without affecting (e.g., changing) the position of the lower linkage. In some embodiments, the lifting implement 50 includes actuators (e.g., electric motors, hydraulic motors, etc.), shown as lifting actuators 88, to facilitate movement of the upper four-bar linkage 52 and/or the lower four-bar linkage 54. For example, the upper four-bar linkage 52 may have a first actuator to adjust the height of the upper four-bar linkage 52, and the lower four-bar linkage 54 may have a second actuator to adjust the height of the lower four-bar linkage 54. In some embodiments, the lifting implement 50 includes interfaces (e.g., handles, shafts, cables, etc.) to manually facilitate movement of the upper four-bar linkage 52 and lower four-bar linkage 54. For example, the pivot assembly 56 may include a handle that may be moved (e.g., cranked) to adjust the linkages. The controls enclosure 18 may include components (e.g., battery, motor controllers, etc.) to control movement of the lifting implement 50. For example, the controls enclosure 18 can include a battery to provide energy to the actuators of the linkages, and/or a motor controller to control the lifting actuators 88.

Although the lifting implement 50 is shown to have two linkages, the lifting implement 50 may have any number of linkages. For example, the lifting implement may have the upper four-bar linkage 52 and the lower four-bar linkage 54 coupled by the pivot assembly 56. As another example, the lifting implement may include a third linkage pivotably coupled to the upper four-bar linkage 52 by a second pivot assembly 56. The number of linkages may correspond to a desired maximum height of the lift device 10. For example, a lift device with two linkages may have a maximum height of three meters, and a lift device with four linkages may have a maximum height of six meters.

The lifting implement 50 may be coupled to a platform 60 to contain (e.g., hold, carry) a load (e.g., product) while the lifting implement 50 is being raised or lowered, and/or while the tractive elements 14 are moving the frame 12. In some embodiments, the upper four-bar linkage 52 and the lower four-bar linkage 54 are sized, shaped, and/or spaced such that the lifting implement 50 maintains the platform 60 substantially parallel to the frame 12 (e.g., substantially horizontal) throughout the range of motion of the lifting implement. The size, shape, and/or other features of the platform 60 may be customizable (e.g., changeable) based on the load type. According to the exemplary embodiment shown in FIG. 2, the platform 60 is an adjustable platform for installing one or more components. In some embodiments, the platform 60 includes actuators or other machinery to adjust dimensions of the platform 60. For example, the platform 60 may be a telescoping boom with an adjustable surface area. The controls enclosure 18 may include components (e.g., battery, motor controllers, etc.) to control adjustments to the platform 60. For example, the controls enclosure 18 may include a battery to provide energy to the actuators of the platform 60, and/or a motor controller to control movement of the actuators (e.g., to change dimensions of the platform 60). According to the exemplary embodiment shown in FIG. 3, the platform 60 is a cabin with a floor surface and barrier walls. In alternate embodiments, the platform 60 may not include walls.

### Lift Device Tractive System

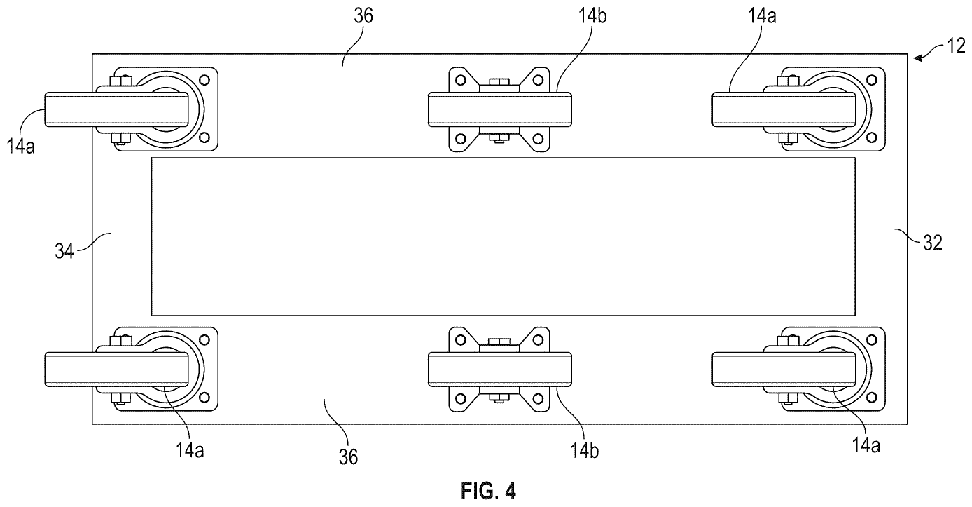

Referring to FIG. 4, the tractive elements 14 (e.g., wheels) may be disposed (e.g. positioned) on a bottom surface of the frame 12. In some embodiments, the tractive elements 14 are positioned in two rows extending longitudinally across the sides 36 of the frame. For example, the frame 12 may include a first row of tractive elements 14 spanning across a first side 36, and a second row of tractive elements 14 spanning across a second side 36. The position of each tractive element 14 in each respective row may be substantially the same. For example, a first tractive element 14 in the first row may be positioned directly across (e.g., laterally) from a first tractive element 14 in the second row.

The tractive elements 14 may allow the frame 12 to move forward or backward in a straight line and/or rotate about a center point of the frame 12. In some embodiments, each tractive element 14 may be either a fixed caster or a swivel caster. As described herein, a fixed caster refers to a wheel (e.g., or a set of wheels) that only has a forward and backward range of motion. For example, a fixed caster may not be able to adjust its angular position relative to the frame 12. As described herein, a swivel caster refers to a wheel (e.g., or a set of wheels) that has an increased range of motion relative to a fixed caster. For example, a swivel caster may be able to adjust its angular position relative to the frame 12. Since swivel casters can adjust their angular position relative to the frame 12, the frame 12 can turn (e.g., reposition, rotate) when the swivel casters are turned.

According to the exemplary embodiment of FIG. 4, each row of tractive elements 14 may include a combination of fixed casters 14b and swivel casters 14a. For example, a first tractive element 14 of each row (e.g., tractive element 14 closest to the front 32) may be a swivel caster, a last tractive element 14 of each row (e.g., tractive element 14 closest to the back 34) may be a swivel caster 14a, and a middle tractive element 14b of the row (e.g., tractive element 14b between first tractive element 14a and last tractive element 14a may be a fixed caster 14b. Arranging fixed casters 14b between swivel casters 14a may allow for the frame 12 to be moved both linearly and rotatably, which may be desired for certain operations. Although each row is shown to include three tractive elements 14, it should be understood that the frame may support any number of tractive elements with any arrangement of fixed casters and swivel casters.

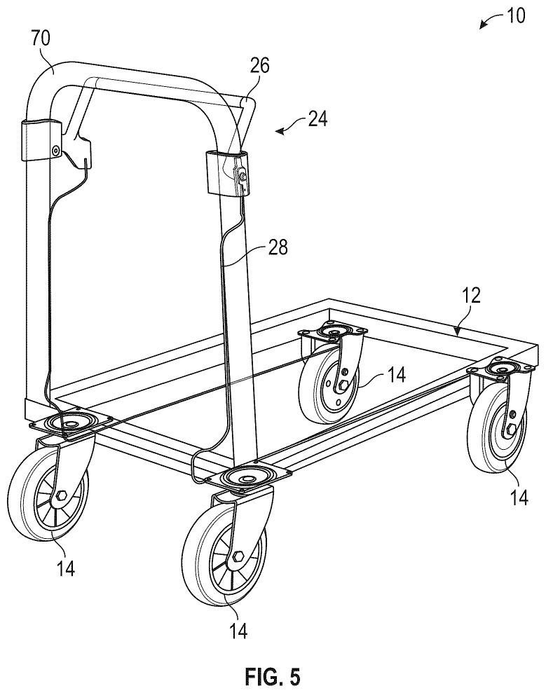

Referring to FIG. 5, the tractive elements 14 that are fixed casters 14b may be included in a braking system 24. For example, the braking system 24 may be a dead man braking system. In the dead man braking system 24, movement of the lift device 10 is restricted, unless an operator of the lift device 10 disengages (e.g., unlocks) with the braking system 24, thereby disabling the brakes. According to the exemplary embodiment shown in FIG. 5, the handle 70 includes a braking bar 26 to switch the braking system 24 between an engaged state and a disengaged state. In other embodiments, the braking bar may be a cable, a lever arm, or a different component that the operator (e.g., of the lift device 10) can interact with. When the braking bar 26 is in the engaged state (e.g., positioned away from the handle, brakes may be deployed on the fixed casters, restricting movement of the lift device 10. The braking bar 26 may be coupled to a brake line 28. In the engaged state, the brake line 28 may allow springs to press brake shoes onto a center portion of the fixed casters (e.g., similar to a drum brake), restricting movement of the tractive elements 14. When the braking bar 26 is in the disengaged state (e.g., positioned towards the handle 70), the brakes may be removed from the fixed casters (e.g., due to movement of the brake line 28), allowing movement tractive elements 14. For example, the brake line 28 may be retracted (e.g., pulled), causing enough tension in the brake line for the springs to pull the brake shoes off of the center of the fixed castors, thereby allowing the fixed castors to move (e.g., rotate).

### Adjustable Platform for Lift Device

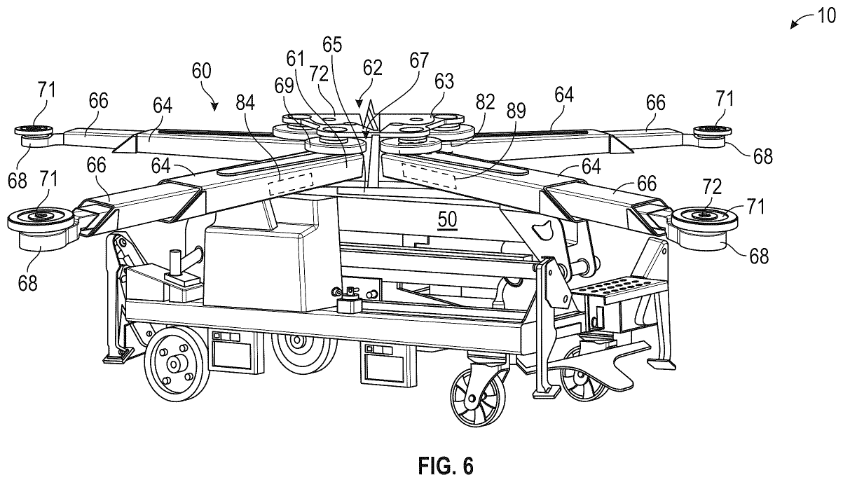

Referring to FIG. 6, the platform 60 may be adjustable to contain (e.g., hold, support, lift, carry, etc.) loads of different sizes. The platform 60 is shown to include a center platform 62 and a plurality of arms 64 extending outwardly from the center platform 62. The center platform may define a top surface 63 and a bottom surface 65. The bottom surface 65 may be coupled with (e.g., connected to) the lifting implement 50. The top surface 63 may be configured to hold a load, or a portion of a load. For example, the top surface 63 can be sized such that a small load, such as an air conditioning unit, can rest on the top surface 63. The top surface 63 and bottom surface 65 can be any shape. For example, the top surface 63 and bottom surface 65 may be circular, rectangular, triangular, or trapezoidal, among other shapes. The platform 60 may include any number of arms 64, and the number of arms may be based on the shape of the center platform 62.

The center platform 62 may define one or more openings (e.g., gaps, spaces, etc.) between the top surface 63 and the bottom surface 65, shown as center openings 67. The center openings 67 may have a height spanning a distance between the top surface and the bottom surface 65. The center openings 67 may be sized to accept (e.g., hold, contain) the plurality of arms 64. For example, a proximal end 61 of each arm 64 may be contained in the center openings 67. The center openings 67 may include a plurality of arm interfaces 69 configured to secure (e.g., couple) the plurality of arms to the center platform 62. For example, the number of arm interfaces 69 may be equal to the number of arms 64, and the proximal end 61 of each arm 64 may be inserted into one of the arm interfaces 69. The arm interfaces 69 may include a fastener (e.g., bolt) to secure (e.g., couple) the arms 64 to the center platform 62. For example, a proximal end 61 of an arm 64 may include an opening that aligns with an opening of an arm interface 69, and a fastener may be inserted into the openings of the arm interface 69 and the arm 64, securing the arm 64 to the arm interface 69.

In some embodiments, the center openings 67 may include (e.g., contain, store) one or more pivot actuators 82 to adjust angular positions of (e.g., pivot) the plurality of arms 64. The arm interfaces 69 and/or the arms 64 may be positioned to have a range of motion relative to other arms. For example, a first arm 64 and a second arm 64 may be pivotable such that an angle between the first arm 64 and the second arm 64 can be any angle between 0 degrees and 90 degrees. The pivot actuators 82 may facilitate (e.g., cause) movement of the arms 64. For example, the pivot actuators 82 may adjust (e.g., increase, decrease) the angle between a first arm 64 and a second arm 64. The pivot actuators 82 may facilitate movement of multiple arms 64 or may facilitate movement of arms 64 individually. For example, a pivot actuator 82 may cause movement (e.g., together, apart) of a first arm 64 and a second arm 64 simultaneously. As another example, a pivot actuator 82 may cause movement of a first arm 64 towards or away from a second arm 64, without moving the second arm 64. In some embodiments, the pivot actuators 82 facilitate movement of the arms 64 by pivoting the arms 64 within the arm interfaces 69. In other embodiments, the pivot actuators 82 facilitate movement of the arms 64 by rotating the arm interfaces 69.

The pivot of the arms 64 may be adjusted automatically (e.g., via the pivot actuators 82), and/or manually (e.g., by an operator of the lift device 10). In some embodiments, the arms 64 switch between or are reconfigurable between a locked state and an unlocked state. In the locked state, the arms 64 may be restricted from one or more degrees of movement i.e., pivoting, extending, etc. In the unlocked state, the arms 64 may be allowed to pivot. For example, each arm 64 may include a latch (e.g., lock) such that when the latch is interacted with (e.g., unlocked), the operator of the lift device 10 can manually pivot the arm and/or operate the pivot actuator 82 to pivot the arm. After pivoting the arm 64 to a desired position, the operator may interact with (e.g., lock) the latch, thereby locking the arm 64 in position so it cannot be further pivoted. The operator may interact with the latch manually and/or electronically. For example, the latch may be an electromechanical latch that the operator can control using a user device. The platform 60 may include one or more arm locking actuators 89 to lock and unlock the latch. For example, the arm locking actuators 89 may move the latch to lock and unlock the arms 64. In some embodiments, the operator may interact with the latch manually (e.g., physically).

The length of each arm 64 may be adjustable to hold (e.g., contain) loads of different sizes. In some embodiments, each arm 64 is a telescoping boom including a plurality of telescoping boom sections 66. Each telescoping boom section 66 may have a smaller width (e.g., thickness) than the preceding telescoping boom section 66 (e.g., adjacent telescoping boom section 66 closer to the proximal end 61). The arms 64 may extend to a plurality of positions between a fully extended state and a fully retracted state. In the fully extended state, each telescoping boom section 66 is fully extended from the preceding telescoping boom section 66, such that the arm 64 is at a maximum length. In the fully retracted state, each telescoping boom section 66 retracts into its preceding telescoping boom section 66, and the arm 64 is at a minimum length.

The arms 64 and/or the center openings 67 may store (e.g., contain, hold, include) one or more arm extension actuators 84. In some embodiments, the arm extension actuators 84 are stored within a first telescoping boom section 66 (e.g., closest to proximal end 61) of each arm 64. In other embodiments, the arm extension actuators 84 are contained in the center openings 67 and are coupled to a proximal end 61 of each arm 64. In other embodiments, the arm extension actuators 84 are positioned elsewhere on the lift device 10. The arm extension actuators 84 may push and/or pull the telescoping boom sections 66, thereby adjusting the length of the arms 64. In some embodiments, the arm extension actuators 84 are configured to adjust the length of multiple arms 64. For example, a single arm extension actuator 84 may adjust a length of each arm 64 by a same amount. In other embodiments, each arm includes an arm extension actuator 84 configured to adjust the length of each arm 64 independently from other arms 64. For example, an arm extension actuator 84 may adjust a length of a first arm 64 without adjusting a length of a second arm 64.

The length of the arms 64 may be adjusted by the arm extension actuators 84, and/or manually by an operator of the lift device 10. The arms 64 may include an extension latch to allow/restrict the arms 64 from extending or retracting. The extension latch may be controlled by the arm latch actuators 89 and/or may be operated manually. In the locked state, the arms 64 may be restricted from extending or retracting. In the unlocked state, the arms 64 may be allowed to extend or retract. After extending/retracting the arm 64 to a desired length, the extension latch may be locked, thereby keeping the arm 64 in its desired position so it cannot be further extended/retracted. The operator may interact with the extension latch electronically. For example, the latch may be an electromechanical latch that is locked and unlocked by the arm latch actuators. The operator may interact with the latch manually (e.g., physically).

Each arm 64 may have a distal end 68 located at an opposite end of the arm 64 from the proximal end 61. For example, the distal end 68 may correspond to a last telescoping boom section 66 of the arm 64 (e.g., furthest from the proximal end 61). The distal end 68 of each arm 64 may include leveling supports, shown as skid plates 71. The skid plates 71 may be adjustable (e.g., moveable) to be positioned at a plurality of heights above the distal end 68. In some embodiments, the height of the skid plates 71 may be based on a shape of the load. For loads that are not symmetrical (e.g., irregularly shaped), the height of the skid plates 71 may be adjusted such that the load remains level (e.g., does not shift) while being lifted. For example, the skid plates 71 may be adjusted to contact specific points of the load, thereby maintaining the position of the load on the arms 64. The height of each skid plate 71 may be independently adjusted from the other skid plates 71. For example, a first skid plate 71 may be at a first height and a second skid plate 71 may be at a second height.

The skid plates 71 may have a textured (e.g., rough, coarse, patterned, etc.) surface to increase a surface area of the skid plates 71, thereby increasing an amount of friction between the load and the skid plates 71. This may further reduce shifting of the load while being lifted (e.g., moved). The skid plates 71 may protect the arms 64 from damage caused by the load. For example, the load may be placed on the skid plates 71 such that the load does not scrape (e.g., damage) a protective coating on the arms 64.

The arms 64 and/or the center platform 62 may include one or more tie-down points 72. In some embodiments, the tie-down points 72 may be areas of the arms 64, the skid plates 71 and/or the center platform where the load can be fastened (e.g., tied-down). For example, the center platform 62 may have a plurality of openings that can allow the load to be strapped (e.g., tied, fastened) to the center platform 62. As another example, the skid plates 71 may have an opening where a strap (e.g., rope, etc.) can fasten the load to the skid plates 71. As another example, the arms 64 may have loops or other interfaces on the surface to accept a strap (e.g., rope, etc.) and fasten the load to the arms 64.

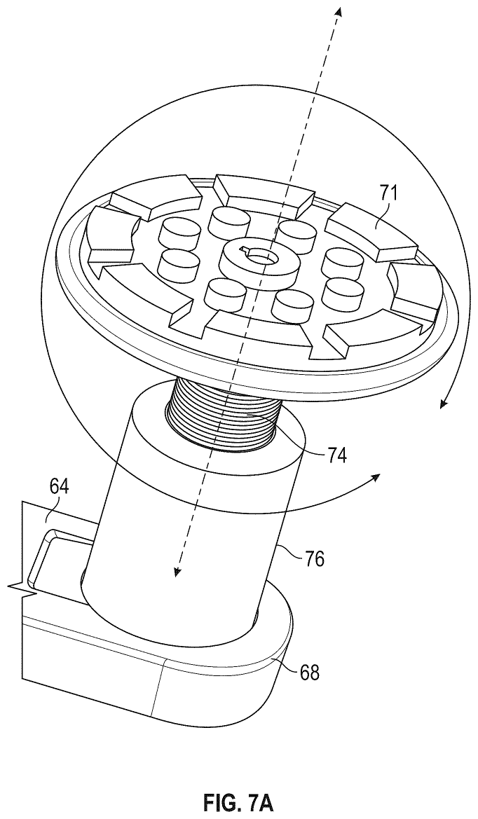

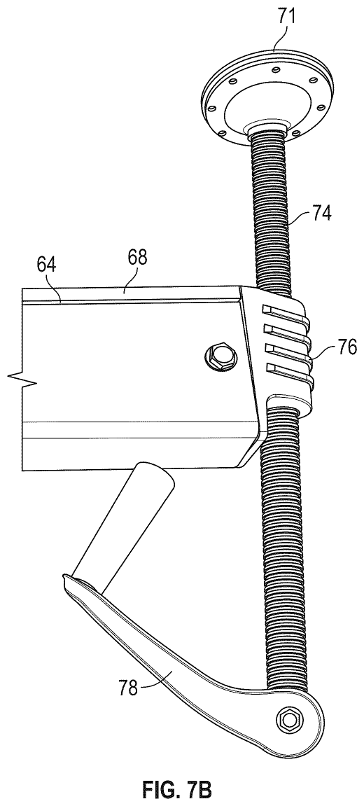

As shown in FIG. 7A, the height of the skid plate 71 relative to the arm 64 (e.g., the distal end 68) may be adjustable responsive to rotation of the skid plate 71. The skid plate 71 may include a screw 74 (e.g., threaded member) that is rotatably coupled to a threaded opening 76 disposed on the distal end 68 of the arm 64. The length of the threaded opening 76 may be approximately equivalent to the length of the screw 74, such that the threaded opening 76 can accept (e.g., hold, contain) the entire screw 74. The screw 74 may partially enter or partially exit the threaded opening 76 responsive to either a clockwise or a counterclockwise direction of rotation. For example, responsive to the skid plate 71 being rotated clockwise, the screw 74 may enter the threaded opening 76 such that a larger portion of the screw 74 is contained (e.g., inserted) in the threaded opening 76. As another example, responsive to the skid plate 71 being rotated counterclockwise, the screw 74 may exit the threaded opening 76 such that a smaller portion of the screw 74 is contain (e.g., inserted) in the threaded opening 76.

As shown in FIG. 7B, the length of the screw 74 may be longer than the length of the threaded opening 76. The screw 74 may be positioned through the threaded opening 76 such that a bottom end of the screw 74 (e.g., an end opposite the skid plate 71) is positioned below the bottom of the threaded opening 76. The bottom end of the screw 74 may include a handle 78 (e.g., shaft, knob, etc.) to rotate the screw 74. For example, the operator can interact with (e.g., rotate) the handle 78 to move the screw 74 up and/or down through the threaded opening 76. Placing a handle 78 on the bottom end of the screw 74 may allow for adjustments to be made to the height of the skid plate 71 while the skid plate 71 is interacting with (e.g., touching) the load, or when the skid plate 71 is not reachable for rotating. For example, the load can be placed on the arm 64, and the handle 78 can be rotated to raise the skid plate 71 to touch (e.g., contact, interact with, etc.) the load.

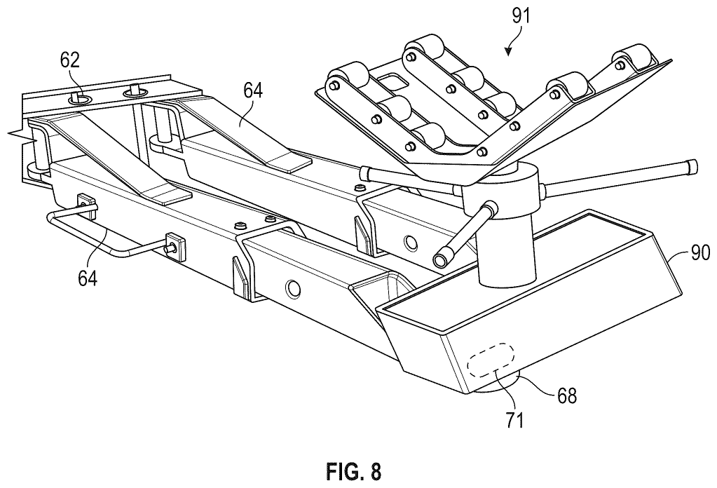

As shown in FIG. 8, multiple arms 64 can be moved (e.g., adjusted, positioned) to perform combined operations. In some cases, the center platform 62 and/or a single arm 64 may be unable to support a load 90 alone. For example, the load 90 may be too large to fit on the center platform 62. As another example, the load 90 may have a center of mass that does not allow the load 90 to balance on one arm 64. The arms 64 may be arranged (e.g., pivoted) such that multiple arms 64 can interact with the load 90 simultaneously. For example, a first arm 64 and a second arm 64 can be adjusted (e.g., moved, repositioned, pivoted, etc.) to a position substantially parallel with one another to support the load 90 for lifting and/or moving operations. Beneficially, this allows the platform 60 to carry longer loads such as pipes using pipe kit 91.

In some embodiments, the arms 64 may be pivoted to adjust the angle between the arms based on the size of the load 90. For example, a first arm 64 and/or a second arm 64 may be pivoted to move closer together or farther apart to be able to support the load 90. A distance between the first arm 64 and/or the second arm 64 may be adjusted based on a length of the load 90. For example, the first arm 64 and/or the second arm 64 may be pivoted such that a center of mass of the load 90 is directly between the first arm 64 and the second arm 64, allowing the load 90 to be moved and/or lifted while remaining stable. In some embodiments, the length of the first arm 64 and/or the second arm 64 may be adjusted based on the length of the load 90. For example, the first arm 64 and/or the second arm 64 may be extended or retracted to increase or decrease a distance between the distal end 68 of the first arm 64 and the distal end 68 of the second arm 64. The distance between the first arm 64 and the second arm 64 may be selected such that the load 90 rests on the skid plates 71.

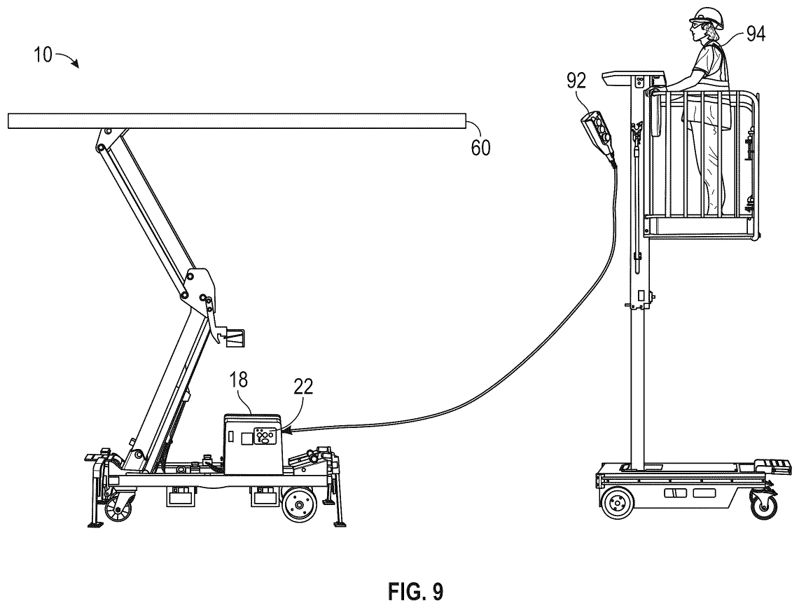

As shown in FIG. 9, the controls enclosure 18 includes a communications interface 22. The communications interface 22 may facilitate communication between components (e.g., motor controllers, battery management systems, etc.) of the controls enclosure 18. The communications interface 22 may facilitate wireless communication and/or wired communication between an operator of the lift device 10 and the control components of the controls enclosure 18. The communications interface 22 is shown to be compatible with a user device 92. The user device 92 may be any device capable of providing instructions to the components of the controls enclosure 18. For example, the user device 92 may be any of a smartphone, computer, wireless controller, or wired controller, among other devices. According to an exemplary embodiment, the user device 92 is a detachable pendant controller.

Referring to FIGS. 6 and 9, the user device 92 may allow for an operator 94 of the lift device 10 to operate the lift device 10 at a plurality of heights. For example, the user device 92 may allow the operator to operate the lift device 10 at the same height as the platform 60. The user device 92 may include a plurality of selectable elements to control (e.g., operate) actuators of the lift device 10. For example, the user device 92 may include selectable elements corresponding to the pivot actuators 82, arm extension actuators 84, lifting actuators 88 (e.g., four bar linkage actuators), prime movers 86, arm locking actuators 89, and/or other actuators of the lift device 10. In some embodiments, the user device 92 allows the operator 94 to lock and/or unlock the arms 64 (e.g., by operating the arm locking actuators 89), such that they can be adjusted (e.g., by the pivot actuators 82 and/or the arm extension actuators 84), regardless of height of the platform 60. For example, the operator 94 may interact with the user device 92 to raise (e.g., lift) the platform 60, unlock the arms 64 at a desired height, adjust the arms 64 (e.g., using the pivot actuators 82, arm extension actuators 84, manually, etc.), and then lock the arms 64 once the arms 64 are in a desired position.

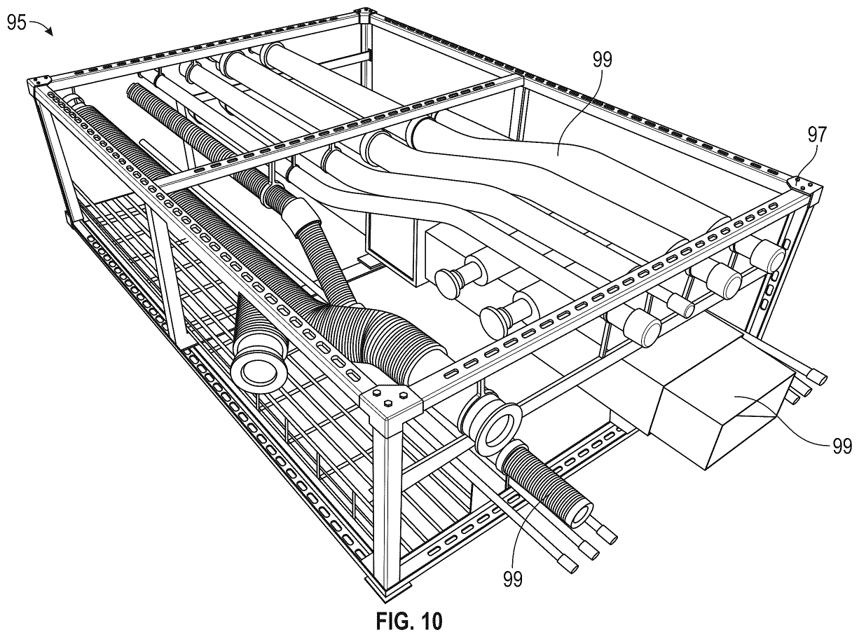

Referring now to FIG. 10, a load 95 for lifting with the lift device 10 is shown, according to an exemplary embodiment. The load 95 may be a pre-constructed models including a plurality of components of different shapes, sizes, weights, and orientations, among other features. For example, the load 95 may include a frame 97 and one or more components 99 coupled to the frame in a final or installed position relative to the one or more other components 99. The components 99 may include pipes, ducting, wires, conduit, etc. or other components which are coupled to a support 97 and pre-built or manufactured as a module or unit prior to installation.

### Lift Device Control System

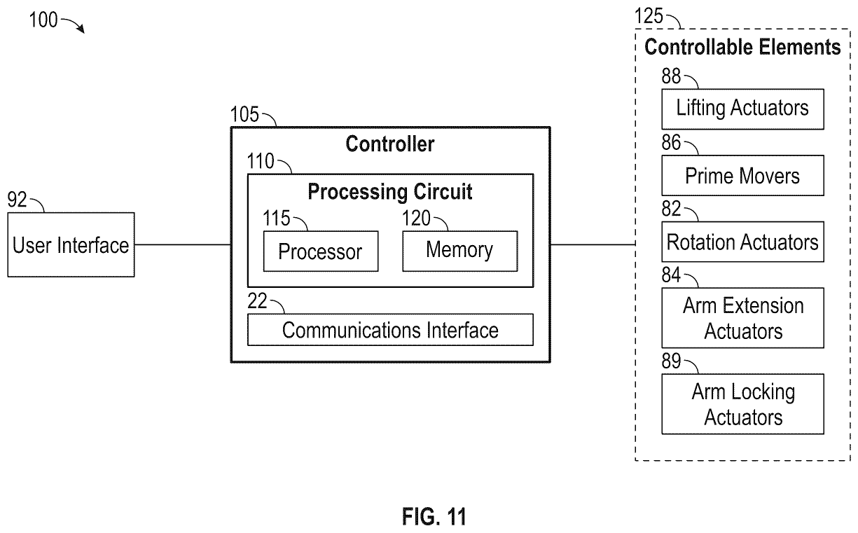

As shown in FIG. 11, the lift device 10 may include a control system 100 to operate one or more actuators to move the tractive system, lift and move loads, and/or perform other operations of the lift device 10. The control system 100 may determine (e.g., define, establish, create, generate) an operation for the lift device 10 based on one or more parameters, including input signals from user devices (e.g., user device 92). For example, the control system 100 may include one or more controllers 105, one or more user devices 92, and a plurality of controllable elements 125, such as the prime movers 86, the lifting actuators 88, the pivot actuators 82, the arm extension actuators 84, and the arm locking actuators 89. According to an exemplary embodiment, the control system 100 may facilitate the determination of an operation for the lift device 10 based on input signals transmitted by the user device 92. For example, the user device 92 may be configured to transmit a plurality of different input signals corresponding to a plurality of selectable elements of the user device 92. For example, the plurality of selectable elements may correspond to the controllable elements 125 of the lift device 10.

The controller 105 may receive input signals from the user device 92 and operate the controllable elements 125 to execute (e.g., perform, complete) an operation of the lift device 10. The controller 105 is shown to include the communications interface 22. The communications interface 22 may facilitate communications between the controller 105, the user device 92, and the controllable elements 125 for control, monitoring, and adjustment to any of the communicably connected devices, displays, systems, actuators, etc.

The communications interface 22 can be or include wired or wireless communications interfaces (e.g., jacks, antennas, transmitter, receivers, transceivers, wire terminals, etc.) for conducting data communications with sensors, devices, systems, etc., of the lift device 10, or other external systems or devices (e.g., an administrative device). In various embodiments, communications via the communications interface 22 can be direct (e.g., local wired or wireless communications) or via a communications network (e.g., a WAN, the Internet, a cellular network, etc.). For example, the communications interface 22 can include an Ethernet card and port for sending and receiving data via an Ethernet-based communications link or network. In another example, the communications interface 22 can include a Wi-Fi transceiver for communicating via a wireless communications network. In some embodiments, communications interface 22 is or includes a power line communications interface. In other embodiments, communications interface 22 is or includes an Ethernet interface, a USB interface, a serial communications interface, a parallel communications interface, etc.

The controller 105 includes a processing circuit 110, a processor 115, and memory 120. The processing circuit 110 can be communicably connected to communications interface 22 such that processing circuit 110 and the various components thereof can send and receive data via communications interface 22. Processor 115 can be implemented as a general purpose processor, an application specific integrated circuit (ASIC), one or more field programmable gate arrays (FPGAs), a group of processing components, or other suitable electronic processing components.

Memory 120 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 120 can be or include volatile memory or non-volatile memory. Memory 120 can include database components, object code components, script components, or any other type of information structure for supporting the various activities and information structures described in the present application. According to some embodiments, memory 120 is communicably connected to processor 115 via processing circuit 110 and includes computer code for executing (e.g., by processing circuit 110 and/or processor 115) one or more processes described herein.

Referring to FIGS. 1, 6, and 9, the controller 105 may receive an input signal from the user device 92. The input signal may indicate a specific operation for an actuator of the lift device 10. For example, the input signal may specify (e.g., indicate) an actuator of the controllable elements 125. As another example, the input signal may specify (e.g., indicate) an operation for the actuator. According to an exemplary embodiment, the input signal may indicate that the lifting actuators 88 should be operated. For example, the input signal may indicate that the lifting actuators 88 should raise or lower the lifting implement 50. According to another exemplary embodiment, the input signal may indicate that the prime movers 86 should be operated. For example, the input signal may indicate that the prime movers 86 should move the lift device 10 in a specific direction, or along a predetermined route. According to another exemplary embodiment, the input signal may indicate that the pivot actuators 82 should be operated. For example, the input signal may specify a direction of pivoting for a specific arm 64 or group of arms 64. According to another exemplary embodiment, the input signal may indicate that the arm extension actuators 84 should be operated. For example, the input signal may specify whether an arm 64 or group of arms 64 should be extended or retracted. According to another exemplary embodiment, the input signal may indicate that the arm locking actuators 89 should be operated. For example, the input signal may specify whether movement of an arm 64 or a group of arms 64 should be locked or unlocked.

In some embodiments, the user device 92 transmits the input signal to the controller 105 for an amount of time corresponding to the operation of the controllable elements 125. For example, upon receiving the input signal, the controller 105 operates the controllable element 125 until the controller 105 stops receiving the input signal. The input signal may correspond to an operator interacting with a selectable element of the user device 92. For example, the input signal may be transmitted to the controller 105 when the operator pushes a button of the user device 92, and the input signal may continue to be transmitted until the operator releases the button.

In some embodiments, the input signal indicates a time of operation and/or an extent (e.g., magnitude) of operation of the controllable elements 125. For example, upon receiving the input signal, the controller 105 may process (e.g., analyze) the input signal to determine at least one of (a) a time of operation of the controllable element 125 or (b) a magnitude of operation. The input signal may be sent responsive to an operator interacting with the user device 92. For example, the operator may enter (e.g., input) into the user device 92 a desired runtime of the controllable elements 125. As another example, the operator may enter (e.g., input) a desired magnitude of operation of the controllable elements 125. The magnitude of operation may correspond to any of a distance, a length, a degree of pivoting, or other measurable indicator of operation of the controllable elements 125.

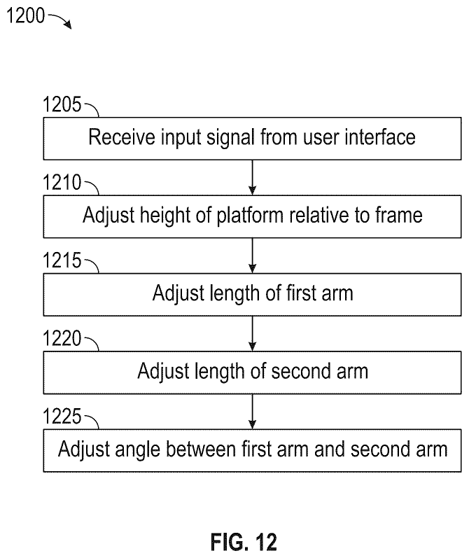

FIG. 12 is a flow diagram of a method 1200 for operation of the lift device 10 using the control system 100. While method 1200 is described to include steps 1205-1225 it should be understood that one or more steps may be excluded from the method 1200, and the steps may be performed in any order. In some embodiments, one or more steps may also be performed a plurality of times. The method 1200 may be implemented by one or more control systems, such as controller 105 of the lift device 10. At step 1205, the controller 105 receives an input signal from the user device 92. The input signal may be a plurality of signals indicating controllable elements 125 to be operated by the controller 105. For example, the input signal may indicate one or more controllable elements 125 and a desired operation of the one or more controllable elements 125. The input signal may be received responsive to an operator interaction with the user device 92. For example, the operator may interact with selectable elements (e.g., buttons, switches, dials, joysticks, etc.) of a pendant controller (e.g., detachable pendant controller), and the input signal may be transmitted based on the selectable elements that the operator interacted with.

At step 1210, the controller 105 adjusts the height of the platform 60 relative to the frame 12. In some embodiments, the controller 105 operates one or more lifting actuators 88 of the lifting implement 50 to adjust the height of the platform. For example, the lifting actuators 88 may raise the platform 60 to bring a load closer to a ceiling of a building. As another example, the lifting actuators 88 may lower the platform 60 towards the ground so that a load can be placed on (e.g., loaded onto) the platform 60. The input signal may specify or otherwise indicate a desired height of the platform 60. For example, the input signal may be received for an amount of time corresponding to the adjustment of the height of the platform 60. As another example, the input signal may specify the desired height of the platform 60.

At step 1215, the controller 105 may adjust a length of a first arm 64 of the platform 60. In some embodiments, the controller 105 operates one or more arm extension actuators 84 to extend or retract the first arm 64. The input signal may specify or otherwise indicate a desired length of the first arm 64. For example, the input signal may be received for an amount of time corresponding to the adjustment of the length of the first arm 64. As another example, the input signal may specify the desired length of the first arm 64. The desired length of the first arm 64 may correspond to a desired distance between a skid plate 71 of the first arm 64 and a skid plate 71 of a second arm 64. For example, the desired distance between the skid plate of the first arm 64 and the skid plate 71 of the second arm may correspond to a length of the load, since it may be desired for the load to be stabilized on the skid plates 71 of the first arm 64 and the second arm 64. The desired length of the first arm 64 may correspond to a size of the load. For example, the load may partially rest (e.g., be positioned) on the center platform 62 and partially rest on the first arm 64. Based on the size of the load, the first arm 64 can be extend such that the entire load can be contained (e.g., rested) on the platform 60.

At step 1220, the controller 105 may adjust the length of the second arm 64 of the platform 60. In some embodiments, the controller 105 operates one or more arm extension actuators 84 to extend or retract the second arm 64. The input signal may specify or otherwise indicate a desired length of the second arm 64. For example, the input signal may be received for an amount of time corresponding to the adjustment of the length of the second arm 64. As another example, the input signal may directly specify the desired length of the second arm 64. The desired length of the second arm 64 may correspond to the length of the first arm 64. In some embodiments, the desired length of the second arm 64 may be the same as the length of the first arm 64 to achieve an even distribution of load weight between the first arm and the second arm, and/or ensure that the entire load is contained on the platform 60. In some embodiments, the desired length of the second arm 64 may be different than the length of the first arm 64 to allow the platform 60 to handle irregularly shaped loads.

At step 1225, the controller 105 adjusts an angle between the first arm 64 and the second arm 64. In some embodiments, the controller 105 operates one or more pivot actuators 82 to pivot the first arm 64 and/or the second arm 64 towards or away from one another. The input signal may specify or otherwise indicate a desired angle between the first arm 64 and the second arm 64. For example, the input signal may be received for an amount of time corresponding to the pivoting of the first arm 64 and/or the second arm 64. As another example, the input signal may directly specify the desired angle between the first arm 64 and the second arm 64. The angle between the first arm 64 and the second arm 64 may be based on the size of the load. For example, if an initial angle between the first arm 64 and the second arm 64 is too wide, the load may fall through a gap between the first arm 64 and the second arm 64. Accordingly, the first arm 64 and the second arm 64 may be brought closer together to hold and secure the load.

### Coordinated Control of Multiple Lift Devices

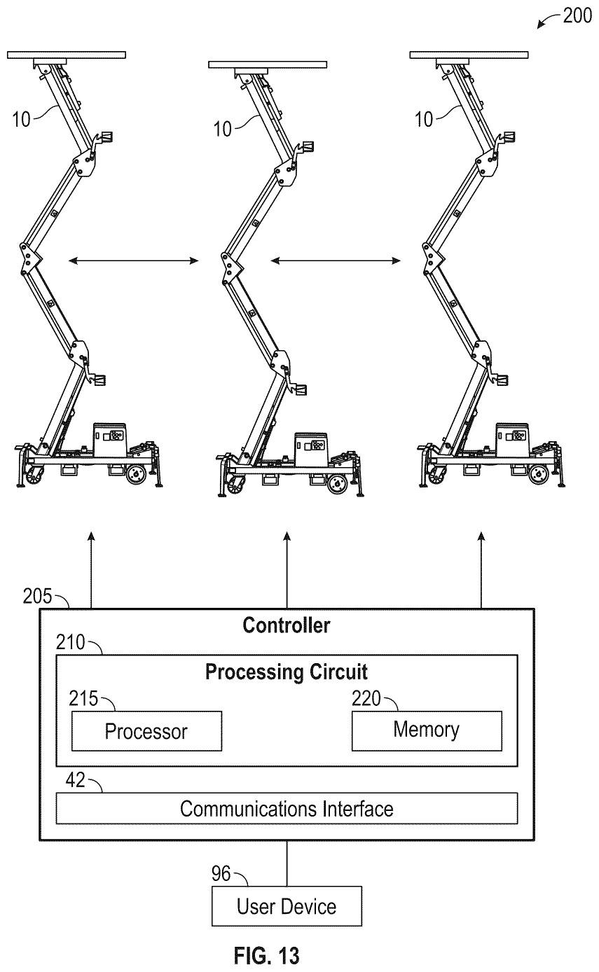

FIG. 13 depicts a control system 200 for controlling (e.g., operating, assigning, coordinating) multiple lift devices 10. The control system 200 may include any of the components of the control system 100 and/or perform the same operations as control system 100. The control system 200 is shown to include a plurality of lift devices 10. Although three lift devices 10 are shown, any number of lift devices 10 can be included in the control system 200.

The control system 200 is shown to include a controller 205. In some embodiments, the controller 205 includes the controller 105. For example, the controller 205 can include a controller 105 of each lift device 10 of the control system 200, or may be configured to control (e.g., transmit instructions to) the controller 105 of each lift device 10. For example, the controller 205 may be a remote server communicatively coupled with each controller 105 of the lift devices 10. The controller 205 includes a processing circuit 210, a processor 215, and memory 220. Processor 215 can be implemented as a general purpose processor, an application specific integrated circuit (ASIC), one or more field programmable gate arrays (FPGAs), a group of processing components, or other suitable electronic processing components.

Memory 220 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 220 can be or include volatile memory or non-volatile memory. Memory 220 can include database components, object code components, script components, or any other type of information structure for supporting the various activities and information structures described in the present application. According to some embodiments, memory 220 is communicably connected to processor 215 via processing circuit 210 and includes computer code for executing (e.g., by processing circuit 210 and/or processor 215) one or more processes described herein.

The controller 205 includes a communications interface 42. The processing circuit 210 can be communicably connected to the communications interface 42 such that processing circuit 210 and the various components thereof can send and receive data via communications interface 42. In some embodiments, the communications interface 42 includes the communications interface 22. In other embodiments, the communications interface 42 is communicatively coupled to the communications interface 22 of each lift device 10.

The communications interface 42 can be or include wired or wireless communications interfaces (e.g., jacks, antennas, transmitter, receivers, transceivers, wire terminals, etc.) for conducting data communications with sensors, devices, systems, etc., of lift devices 10, or other external systems or devices (e.g., an administrative device, a user device). In various embodiments, communications via communications interface 42 can be direct (e.g., local wired or wireless communications) or via a communications network (e.g., a WAN, the Internet, a cellular network, etc.). For example, communications interface 42 can include an Ethernet card and port for sending and receiving data via an Ethernet-based communications link or network. In another example, the communications interface 42 can include a Wi-Fi transceiver for communicating via a wireless communications network. In some embodiments, communications interface 42 is or includes a power line communications interface. In other embodiments, communications interface 42 is or includes an Ethernet interface, a USB interface, a serial communications interface, a parallel communications interface, etc.

The control system 200 includes a user device 96 that is communicatively coupled with the controller 205. In some embodiments, the user device 96 is the same as the user device 92. In other embodiments, the user device 96 is a different user device than the user device 92. The user device 96 may select a plurality of lift devices 10 to be used for a combined operation. As described herein, a “combined operation” refers to an operation (e.g., task) of the control system 200 that uses two or more lift devices 10 to complete (e.g., execute). The user device 96 may select the plurality of lift devices 10 responsive to the user device 96 transmitting an identifier of the lift devices 10 to the controller 205. For example, the user device 96 may retrieve an identifier of the lift devices by scanning a quick response (QR) code of the lift devices 10, a bar code of the lift devices 10, or performing a radio-frequency identification (RFID) scan of the lift devices 10, among other identification methods. The user device 96 may transmit the identifiers of the lift devices 10 to the controller 205 (e.g., via wired connection and/or wireless connection).

The user device 96 may transmit configuration information for each lift device 10 of the control system 200. According to an exemplary embodiment, the user device may determine a location, a height, and/or a platform 60 arrangement for each lift device. For example, the configuration information may include a plurality of instructions to the controller 205 including (a) an identifier of the lift device 10, (b) an identifier of the controllable elements of the lift device 10, and (c) one or more commands for each identified controllable element.

The controller 205 may receive the configuration information from the user device 96 at the communications interface 42. The processing circuit 210 may process (e.g., analyze) the configuration information and cause adjustment of each lift device 10 according to the configuration information. For example, the processing circuit may determine a configuration for each lift device 10 based on the configuration information, and transmit the configuration information as a series of commands to the respective lift devices 10. According to an exemplary embodiment, if the configuration information includes configurations for three lift devices 10, the processing circuit 210 may separate the configuration information for each respective lift device 10 (e.g., based on the lift device 10 identifiers) and transmit the separated (e.g., individualized) configuration information as a set of instructions to each lift device 10.

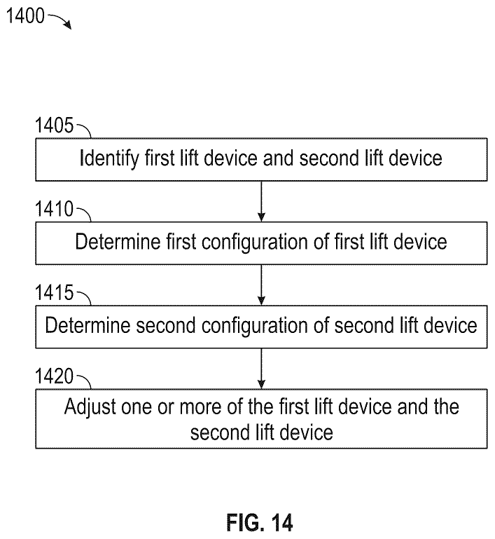

FIG. 14 depicts a flow diagram of a method 1400 for controlling multiple lift devices for a combined operation, using the control system 200. While method 1400 is described to include steps 1405-1420 it should be understood that one or more steps may be excluded from the method 1400, and the steps may be performed in any order. In some embodiments, one or more steps may also be performed a plurality of times. At step 1405, the controller 205 identifies a first lift device 10 and a second lift device 10. The controller 205 may identify the first lift device 10 and the second lift device 10 responsive to receiving identifiers of the first lift device 10 and the second lift device 10 from the user device 96. The user device may retrieve identifiers of lift devices 10 by performing an RFID scan, a bar code scan, and/or a QR code scan of the lift devices 10, among other types of identification processes.

At step 1410, the controller may determine a first configuration of the first lift device 10. The configuration may be determined responsive to receiving configuration information from the user device 96. The configuration information may be associated with the identifier of the first lift device 10, and correspond to any of a location of the first lift device 10, a height of a platform 60 of the first lift device 10, a pivot angle of the arms 64 of the first lift device, an extension length of the arms 64 of the first lift device 10, and/or other features of the first lift device.

At step 1415, the controller 205 may determine a second configuration of the second lift device 10. The configuration may be determined responsive to receiving configuration information from the user device 96. The configuration information may be associated with the identifier of the second lift device 10, and correspond to any of a location of the second lift device 10, a height of the platform 60 of the second lift device 10, a pivot angle of the arms 64 of the second lift device, an extension length of the arms 64 of the second lift device 10, and/or other features of the second lift device 10. In some embodiments, the configuration information of the second lift device may be based on the configuration of the first lift device 10. For example, the configuration information for the second lift device 10 may indicate a distance relative to the first lift device 10, a height relative to the height of the first lift device 10, and/or other information relative to information of the first lift device 10.

At step 1420, the controller 205 may cause an adjustment of one or more of the first lift device 10 or the second lift device according to the configuration information of the first lift device 10 and/or the second lift device 10 according to the configuration information of the second lift device 10. In some embodiments, the controller 205 transmits or otherwise provides instructions to a controller 105 of the first lift device 10. The instructions may cause operation of one or more actuators of the first lift device 10. For example, the instructions may cause operation of a prime mover 86, one or more lifting actuators 88, one or more pivot actuators 82, one or more arm extension actuators 84, and/or one or more arm locking actuators 89 of the first lift device 10. In some embodiments, the controller 205 transmits or otherwise provides instructions to a controller 105 of the second lift device 10. The instructions may cause operation of one or more actuators of the second lift device 10. For example, the instructions may cause operation of a prime mover 86, one or more lifting actuators 88, one or more pivot actuators 82, one or more arm extension actuators 84, and/or one or more arm locking actuators 89 of the second lift device 10.

In some embodiments, the adjustment of the first lift device 10 and the second lift device 10 occurs simultaneously. For example, the instructions may cause the first lift device 10 and the second lift device 10 to move at the same speed, and/or lift their respective platforms 60 at the same speed. This may allow a load to be moved (e.g., lifted, carried, etc.) by both the first lift device 10 and the second lift device 10. For example, the load may be too large to be lifted by either the first lift device 10 or the second lift device 10 alone, and therefore may be partially lifted by both lift devices 10.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the lift device 10 and the production system as shown in the various exemplary embodiments is illustrative only. Additionally, any element disclosed in one embodiment may be incorporated or utilized with any other embodiment disclosed herein. For example, the controller 105 of the exemplary embodiment shown in at least FIG. 11 may be incorporated in the controller 205 of the exemplary embodiment shown in at least FIG. 13. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A lift device comprising:
a frame;
a platform;
a first arm and a second arm coupled to the platform at a proximal end of each of the first arm and the second arm;
one or more actuators configured to adjust at least one of (a) a length of the first arm, (b) a length of the second arm, or (c) an angle between the first arm and the second arm;
a lift apparatus coupled to the frame and the platform configured to adjust a height of the platform relative to the frame; and
a controller configured to:
receive an input signal from a user device;
operate the lift apparatus to adjust the height of the platform relative to the frame;
operate the one or more actuators to adjust the length of the first arm or the second arm; and
operate the one or more actuators to adjust the angle between the first arm and the second arm.

2. The lift device of claim 1, wherein the frame comprises a plurality of wheels coupled to the frame configured to facilitate movement of the frame on a surface.

3. The lift device of claim 2, wherein:
the plurality of wheels includes a set of swivel casters and a set of fixed casters configured to facilitate the frame (a) moving in a forward direction or a backward direction and (b) rotating about a center point of the frame; and
the frame includes a braking system configured to simultaneously restrict movement of each fixed caster of the set of fixed casters, the braking system is activated responsive to an operator interaction with at least one of (a) a cable or (b) a lever arm.

4. The lift device of claim 1, wherein the lift apparatus is an articulated boom lift comprising an upper four-bar linkage and a lower four-bar linkage, the upper four-bar linkage and the lower four-bar linkage configured to adjust the height of the articulated boom lift between a raised position and a collapsed position.

5. The lift device of claim 1, wherein the first arm is a telescoping boom comprising a plurality of telescoping boom sections, and wherein the one or more actuators are configured to extend or retract the plurality of telescoping boom sections to adjust the length of the first arm.

6. The lift device of claim 1, wherein the first arm is reconfigurable between an unlocked state and a locked state, wherein, in the unlocked state, the length of the first arm is adjustable, and wherein, in the locked state, the length of the first arm and the length of the second arm are fixed.

7. The lift device of claim 1, wherein the controller is configured to adjust a position of the first arm without adjusting a position of the second arm.

8. The lift device of claim 1, wherein a distal end of each of the first arm and the second arm includes a skid plate configured to maintain a position of a load positioned on the first arm and the second arm, and wherein the distal end of the first arm comprises a leveling support coupled to the skid plate configured to adjust a height of the skid plate relative to the first arm.

9. The lift device of claim 1, wherein the user device is a pendant controller configured to permit an operator to interact with the controller at a plurality of heights of the platform.

10. The lift device of claim 1, wherein the platform defines a plurality of openings each configured to receive a tie-down to facilitate coupling a load to the platform.

11. The lift device of claim 1, wherein a distal end of the first arm defines an opening configured to receive a tie-down to facilitate coupling a load to the first arm.

12. The lift device of claim 1, wherein the controller is further configured to:
operate the one or more actuators to adjust at least one of the first arm or the second arm to a position substantially parallel to the other of the first arm or the second arm to support a load; and
operate the one or more actuators to adjust the angle between the first arm and the second arm based on the load.

13. A platform for a lift device comprising:
a first arm and a second arm each comprising a proximal end coupled to the platform;
one or more actuators configured to adjust at least one of (a) a length of the first arm, (b) a length of the second arm, or (c) an angle between the first arm and the second arm; and
a controller configured to:
receive an input signal from a user device;
cause the one or more actuators to adjust the length of the first arm or the second arm; and
cause the one or more actuators to adjust the angle between the first arm and the second arm.

14. The lift device of claim 13, wherein the first arm is a telescoping boom including a plurality of telescoping boom sections, and wherein the one or more actuators are configured to extend or retract the plurality of telescoping boom sections to adjust the length of the first arm.

15. The lift device of claim 13, wherein the controller is configured to adjust a position of the first arm without adjusting a position of the second arm.

16. The lift device of claim 13, wherein a distal end of the first arm and the second arm comprise a skid plate configured to maintain a position of a load positioned on the first arm and the second arm, and wherein the distal end of the first arm comprises a leveling support coupled to the skid plate configured to adjust a height of the skid plate relative to the first arm.

17. A lift device system comprising:
a first lift device comprising:
a frame;
a platform;
a first arm and a second arm each comprising a proximal end coupled to the platform;
one or more actuators configured to adjust at least one of (a) a length of the first arm, (b) a length of the second arm, or (c) an angle between the first arm and the second arm; and
a lift apparatus coupled to the frame and the platform configured to adjust a height of the platform relative to the frame;
a second lift device; and
a controller configured to:
identify the first lift device and the second lift device for a combined operation;
determine a first configuration for the first lift device;
determine a second configuration for the second lift device based on the determined first configuration of the first lift device;
cause a first adjustment of at least one of the lift apparatus, the first arm, or the second arm of the first lift device based on the determined second configuration of the second lift device; and
cause a second adjustment of at least one of a lift apparatus, a first arm, or a second arm of the second lift device based on the first adjustment of the first lift device.

18. The lift device system of claim 17, wherein the controller is configured to identify the first lift device and the second lift device responsive to at least one of (a) scanning quick response (QR) codes of the first lift device and the second lift device or (b) radio-frequency identification (RFID) communications with the first lift device and the second lift device.

19. The lift device system of claim 17, wherein the first configuration and the second configuration are based on dimensions of a load of at least one of the first lift device and the second lift device.

20. The lift device system of claim 19, wherein:
the first adjustment comprises at least one of:
operating a prime move of the first lift device to adjust a position of the first lift device;
operating one or more actuators to adjust the height of the platform of the first lift device; or
operating the one or more actuators to adjust a pivot angle of the first arm of the second arm of the first device.
